(19) United States
(12) Patent Application Publication
(10) Pub. No.: US 2005/0216931 A1
(43) Pub. Date: Sep. 29, 2005

(54) Content purchase support apparatus

(75) Inventor: Kentaro Yamamoto, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/088,796

(22) Filed: Mar. 25, 2005

(30) Foreign Application Priority Data
Mar. 25, 2004 (JP) P2004-090667

(51) Int. Cl. H04N 7/025; G06F 17/60; H04N 7/16; H04N 7/10; G06F 3/00; H04N 7/173

(52) U.S. Cl. 725/8; 725/60; 725/61; 725/87; 705/26; 705/27

(57) ABSTRACT

A content purchase support apparatus including: a content specification unit that allows a user to input an entry for specifying pay content to be purchased; a content determination unit that determines based on program information whether or not content same as the pay content specified by the user through the content specification unit is broadcast in charge-free within a predetermined time period; and a purchase prevention processing unit that performs purchase prevention processing of the specified pay content when the content determination unit determines that the content same as the specified pay content will be broadcast in charge-free within the predetermined time period.

The present disclosure relates to the subject matter contained in Japanese Patent Application No. 2004-090667 filed on Mar. 25, 2004, which is incorporated herein by reference in its entirety.

### BACKGROUND OF THE INVENTION

1. Field of the Invention

The present invention relates to a content purchase support apparatus, a content purchase support method, a content purchase support program, and a recording medium recording the program.

2. Description of the Related Art

In recent years, fee-based services for distributing or broadcasting content via the Internet, a cable TV, a broadcast wave from a communication satellite, etc., have become widespread. In some content distributed or broadcast by the pay-based services, the viewing time limit may be set and thus an apparatus for preventing the user from missing content is also proposed. (For example, refer to JP-A-2003-199009.) In the apparatus, an electronic program guide (EPG) is used to inform the user a predetermined time before the viewing time limit.

With the electronic program guide, SI (Service Information: Various pieces of information stipulated for convenience of program selection) sent from broadcast stations is used to form program information in each receiver as program selection means.

### SUMMARY OF THE INVENTION

The apparatus in the related art described above enables the user to be prevented from missing content purchased in the fee-based service.

However, when the user purchases content in fee-based service as described above, the same content (for example, the same movie) as the content whose purchase is specified by the user may be broadcast in charge-free in a terrestrial broadcast, a satellite broadcast, etc., within a predetermined period.

In such a case, if the user knows that he or she can free view the same content within the predetermined period (for example, period in which the user can postpone viewing the content), the user may view the broadcast in charge-free without daring to purchase the content in the fee-based service (pay content).

However, not to purchase unnecessary pay content, the user needs to check a program guide of a newspaper, a magazine, etc., to see if the same content will be broadcast in charge-free within the predetermined period; labor and time are taken. Although the electronic program guide service described above has been provided in recent years, a machine such as a TV, a video, or a PC (personal computer) supporting the electronic program guide is required, and the user also needs to check the electronic program guide to see if the same content will be broadcast in charge-free within the predetermined period.

Since the user needs thus to check the program guide to see if the same content will be broadcast in charge-free, it is difficult to instantly and easily prevent the user from purchasing unnecessary pay content. It is furthermore difficult to prevent the user from purchasing unnecessary pay content particularly if the user attempts to purchase pay content using a vehicle-installed AV (Audio Visual) machine connected to fee-based service for distributing or broadcasting content or attempts to purchase (or rent) sold or rented pay content of a DVD, etc., from a store or a rental store.

It is therefore one of objects of the invention to provide a content purchase support apparatus for preventing the user from purchasing the same content as content which will be broadcast in charge-free within a predetermined time period in pay service without knowing the fact that the content will be broadcast in charge-free within the predetermined time period.

According to a first aspect of the invention, there is provided a content purchase support apparatus including: a content specification unit that allows a user to input an entry for specifying pay content to be purchased; a content determination unit that determines based on program information whether or not content same as the pay content specified by the user through the content specification unit is broadcast in charge-free within a predetermined time period; and a purchase prevention processing unit that performs purchase prevention processing of the specified pay content when the content determination unit determines that the content same as the specified pay content will be broadcast in charge-free within the predetermined time period.

According to a second aspect of the invention, there is provided a content purchase support method including: a content specification step for allowing a user to input an entry for specifying pay content to be purchased; a content determination step for determining based on program information whether or not content same as the pay content specified by the user will be broadcast in charge-free within a predetermined time period; and a purchase prevention processing step for performing purchase prevention processing of the specified pay content when determined in the content determination step that the content same as the specified pay content is broadcast in charge-free within the predetermined time period.

According to a third aspect of the invention, there is provided a content purchase support program product for causing a computer to execute: a content specification step for allowing a user to input an entry for specifying pay content to be purchased; a content determination step for determining based on program information whether or not content same as the pay content specified by the user will be broadcast in charge-free within a predetermined time period; and a purchase prevention processing step for performing purchase prevention processing of the specified pay content when determined in the content determination step that the content same as the specified pay content is broadcast in charge-free within the predetermined time period.

### BRIEF DESCRIPTION OF THE DRAWINGS

In the accompanying drawings:

FIG. 1 is a block diagram to show the internal configuration of a content purchase support apparatus in a first embodiment of the invention;

FIG. 2 is a flowchart to show an operation procedure of the content purchase support apparatus in the first embodiment of the invention;

FIG. 3 is a flowchart to show a procedure of content search processing;

FIG. 4 is a flowchart to show a procedure of EPG determination processing;

FIG. 5 is a flowchart to show a procedure of purchase prevention processing;

FIG. 6 is a flowchart to show a procedure of nonpurchase time processing;

FIG. 7 is a flowchart to show a procedure of content purchase processing;

FIG. 8 is a flowchart to show a processing procedure example for the user (operator) to purchase pay content with the content purchase support apparatus installed in a vehicle-installed AV machine;

FIG. 9 is a block diagram to show the internal configuration of a content purchase support apparatus in a second embodiment of the invention;

FIG. 10 is a flowchart to show a processing procedure example for the content purchase support apparatus installed in a mobile telephone terminal to determine whether or not the content recorded on a DVD, etc., will be broadcast in charge-free;

FIG. 11 is a block diagram to show the internal configuration of a content purchase support apparatus in a third embodiment of the invention; and

FIG. 12 is a flowchart to show a processing procedure example for the content purchase support apparatus installed in a cashier terminal to determine whether or not the content recorded on a DVD, etc., will be broadcast in charge-free.

### DETAILED DESCRIPTION OF THE PREFERRED EMBODIMENTS

A content purchase support apparatus and a content purchase support method in each embodiment of the invention will be discussed in detail with reference to the accompanying drawings.

In the accompanying drawings to describe each embodiment, parts having the same function are denoted by the same reference numeral.

First Embodiment

A content purchase support apparatus of a first embodiment of the invention will be discussed.

The embodiment is an example of a content purchase support apparatus installed in a vehicle-installed AV machine (vehicle-installed machine).

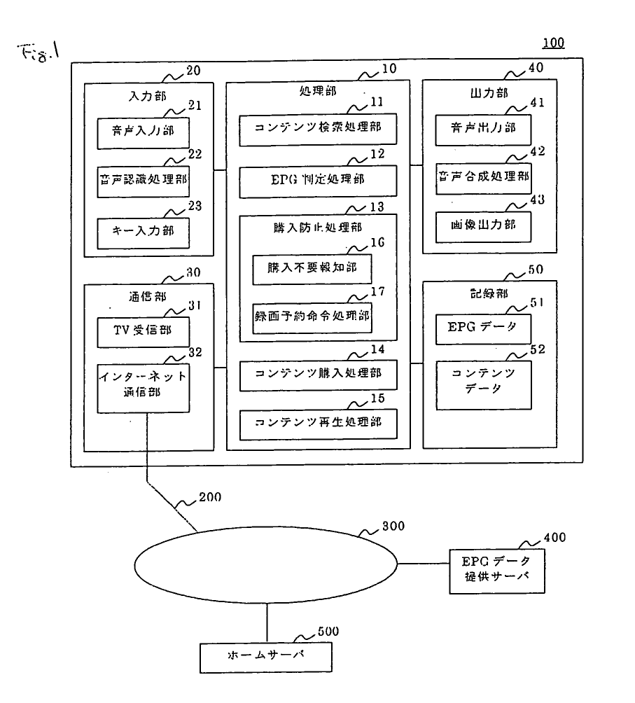

FIG. 1 is a block diagram to show the internal configuration of a content purchase support apparatus installed in a vehicle-installed AV machine. A content purchase support apparatus 100 is mainly includes a processing section 10, an input section 20, a communication section 30, an output section 40, a record section 50, etc. The vehicle-installed AV machine may include a record and playback section of record media of a DVD, a CD, etc., and a car navigation function section (not shown) in addition to the components of the content purchase support apparatus mentioned above.

The processing section 10 includes a content search processing section 11, an EPG (electronic program guide) determination processing section 12, a purchase prevention processing section 13, a content purchase processing section 14, a content playback processing section 15, etc. The content search processing section 11 accesses a pay content server (not shown) on the Internet through the communication section 30 and makes a search for any desired pay content from the category, etc. The EPG determination processing section 12 references EPG data acquired through the communication section 30 from an EPG data providing server 400 (described later) and determines whether or not the specified pay content will be broadcast in charge-free within the preset time period.

The purchase prevention processing section 13 is a block for performing processing to prevent unnecessary purchase if the specified pay content will be broadcast in charge-free within the predetermined time period. It includes a purchase nonnecessity notification section 16 for notifying the user (operator) that the specified content need not be purchased, and a record pre-selection instruction processing section 17 for recording the broadcast in charge-free content in a remote recording apparatus (home server 500, etc.,) if the user (operator) quits purchasing the content.

If purchasing the pay content is confirmed, the content purchase processing section 14 performs charging processing, downloads the content, etc., through the communication section 30. The content playback processing section 15 plays back the downloaded content.

The input section 20 includes a voice input section 21 implemented as a microphone, a voice recognition processing section 22 for outputting voice acquired through the microphone as text information, a key input section 23 implemented as a keyboard, etc., and the like.

The communication section 30 includes a TV reception section 31 for receiving terrestrial TV broadcasts, an Internet communication section 32 for transmitting and receiving data to and from the EPG data providing server 400, the home server 500, the pay content server (not shown) etc., through a radio telephone network 200 and an Internet network 300, and the like.

The output section 40 includes a voice output section 41 implemented as a speaker, a voice synthesis processing section 42 for converting text information into voice and outputting the voice, an image output section 43 implemented as a display for displaying text and an image, and the like.

The record section 50 is implemented as record media for storing EPG data 51 and content data 52.

The processing section 10 is includes a CPU, RAM, and the like and the functions of the sections described above in the processing section 10 are provided by the CPU executing various programs. The functions of the sections are described later.

Next, the operation of the described content purchase support apparatus is as follows:

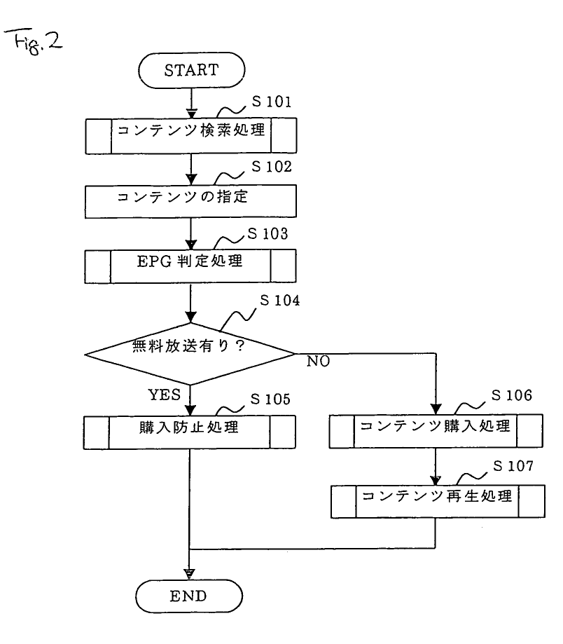

FIG. 2 is a flowchart to show an operation procedure of the content purchase support apparatus in the first embodiment of the invention. To begin with, when an operation mode to purchase content is entered as the user (operator) of the content purchase support apparatus performs key operation, etc., the content search processing section 11 performs content search processing and provides some titles of pay content as purchase candidates (step S101). If the user (operator) specifies any desired content (S102), the EPG determination processing section 12 checks the EPG data to see if the specified content will be broadcast in charge-free (step S103).

Next, the EPG determination processing section 12 determines the check result (S104) and if the content will be broadcast in charge-free, the purchase prevention processing section 13 performs purchase prevention processing of the content (step S105). On the other hand, if the content will not be broadcast in charge-free, the content purchase processing section 14 performs purchase processing of the content (step S106). The content playback processing section 15 performs playback processing of the purchased content.

In specification of the content at step S102, voice of the content title produced by the user (operator) is acquired by the voice input section 21, and the voice recognition processing section 22 converts the voice into text data and outputs the text data to the content search processing section 11.

Next, the content search processing will be discussed in detail. FIG. 3 is a flowchart to show a procedure of the content search processing.

First, to set search conditions, the content search processing section 11 inquires of the user (operator) the search conditions such as the genre, etc., of pay content to make a search for (step S201) . To make an inquiry, the voice synthesis processing section 42 executes voice synthesis and the voice output section 41 outputs voice.

For example, search conditions are inquired by voice such as a message to say that “which genre do you want?” and the user (operator) is prompted to answer the inquiry.

If the user (operator) responds to the inquiry with voice to say the search conditions (genre, etc.,), the search conditions subjected to text processing through the voice input section 21 and the voice recognition processing section 22 are input and set (step S202) (Search condition setting unit).

The content search processing section 11 accesses the pay content server on the Internet via the radio telephone network 200 and the Internet network 300 from the Internet communication section 32 of the communication section 30 (step S203) and makes a search according to the search conditions and acquires a content list (step S204) (search unit).

The content search processing section 11 outputs all or a part of the acquired content list to the voice synthesis processing section 42, and the voice output section 41 outputs the content titles as purchase candidates by voice (step S205). At this time, the image output section 43 may list the content titles.

That is, before the user (operator) specifies pay content to be purchased, the content list is output by voice or is displayed as assistance information to assist the user in entering specification (is provided to the user as assistance information providing unit).

The user (operator) selects any desired content out of the provided content list with reference to the assistance information provided according to the described procedure.

The assistance information also includes the message for prompting the user (operator) to answer the inquiry about the search conditions, etc.

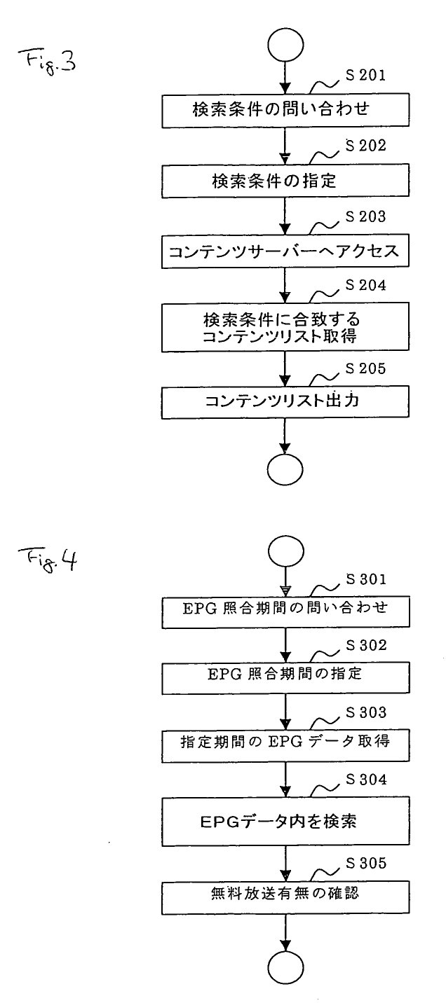

Next, the EPG determination processing will be discussed in detail. FIG. 4 is a flowchart to show a procedure of the EPG determination processing. First, the EPG determination processing section 12 inquires how much time will the user intend to check whether or not the specified content will be broadcast in charge-free over (step S301).

The time period may be set in response to the user's (operator's) requirement, such as two days if the user wants to view the content as early as possible or one week if the user need not view the content urgently and wants to use broadcast in charge-free without purchasing the pay content as much as possible.

If the user (operator) sets the check time period (step S302), the EPG determination processing section 12 accesses the EPG data providing server 400 on the Internet via the radio telephone network 200 and the Internet network 300 from the Internet communication section 32 and acquires the EPG data included over the setup time period (step S303).

Further, the EPG determination processing section 12 checks to see if the same content as the specified content is indicated in the acquired EPG data (step S304) and checks whether or not the content will be broadcast in charge-free (step S305) (search information determination unit).

The determination processing as to whether or not the same content as the content specified by the user (operator) will be broadcast in charge-free is now complete.

The “same content” need not be the content having the title completely matching the title of the content specified and may be similar content. For example, usual version and special version, usual version and live version (music, etc.,), or the like may be regarded as the “same content.”

If the content whose title is output by voice in the content search processing described above includes the same content as the content included in the acquired EPG data, preferably the title of the content is previously deleted before the content list is output by voice.

Accordingly, the content which will be broadcast in charge-free within the predetermined time period can be prevented from being introduced as purchase candidate content. In this case, a procedure of accessing the EPG data providing server 400, acquiring the EPG data, checking to see if the same content is indicated, and checking whether or not the content will be broadcast in charge-free (steps S303 to S305 in the flowchart of FIG. 4) needs to be added preceding the step of outputting the content title by voice (step S205 in the flowchart of FIG. 3).

Inquiry about and specification of the EPG check time period are conducted by voice like the inquiry about and specification of the category described above. The EPG check time period may be preset for always acquiring the EPG data included in the setup time period and checking to see if the same content is indicated in the EPG data without inquiring about the EPG check time period each time.

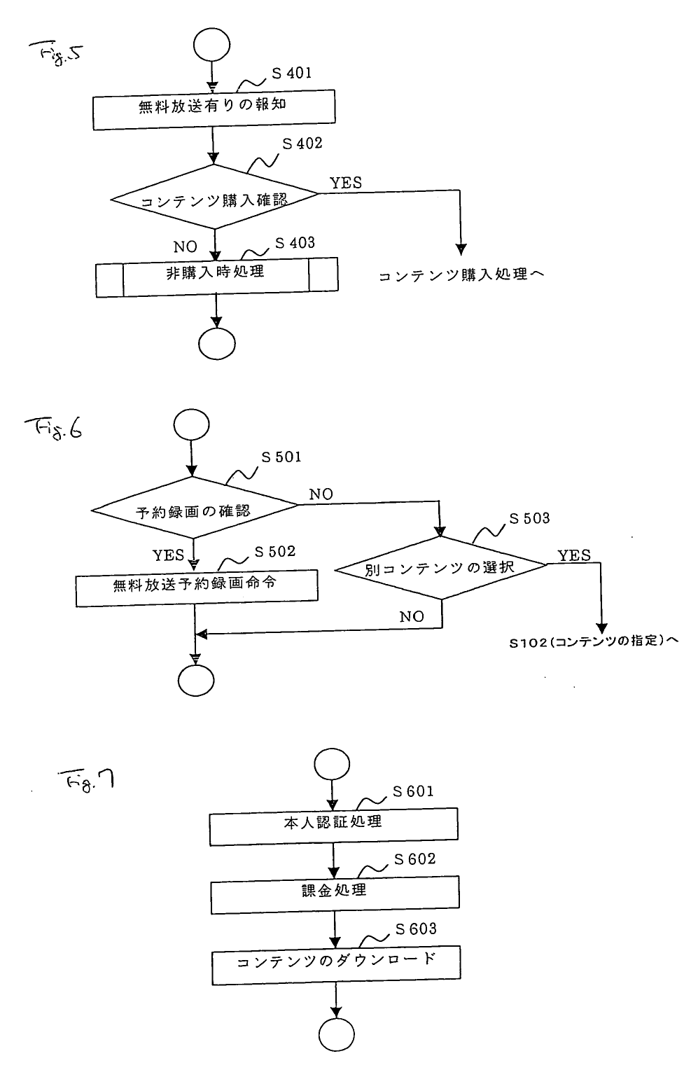

Next, the purchase prevention processing will be discussed in detail. FIG. 5 is a flowchart to show a procedure of the purchase prevention processing. The purchase nonnecessity notification section 16 of the purchase prevention processing section 13 notifies the user (operator) that the same content will be broadcast in charge-free within the predetermined time period (step S401) (confirmation information providing unit).

Further, the purchase prevention processing section 13 inquires of the user (operator) whether or not the user (operator) purchases the pay content (step S402) (purchase determination unit) . If the user specifies no purchase of the pay content, nonpurchase time processing (purchase prevention processing of the specified pay content) is performed (step S403). On the other hand, if the user specifies purchase of the pay content, the process goes to the content purchase processing (step S106 in the flowchart of FIG. 2).

Notifying the user (operator) that the content will be broadcast in charge-free and inquiry about content purchase and response thereto are conducted by voice like the inquiry about and specification of the category described above.

The nonpurchase time processing will be discussed in detail. FIG. 6 is a flowchart to show a procedure of the nonpurchase time processing. First, the purchase prevention processing section 13 inquires of the user (operator) of the content purchase support apparatus by voice whether or not the broadcast in charge-free of the same content as the specified content is to be recorded (step S501).

If the user (operator) specifies record, the record pre-selection instruction processing section 17 accesses the home server 500 through the Internet communication section 32, the radio telephone network 200, and the Internet network 300 and transmits an instruction for recording the broadcast (step S502) (record command unit). The home server 500 includes reception means for receiving broadcasts in charge-free and record means.

On the other hand, if the user (operator) specifies no record, then whether or not another title of content is selected from the same category is inquired (step S503). If the user specifies selection of another title of content, the process goes to the step of specifying the content (step S102 in the flowchart of FIG. 2). The purchase prevention processing if the content will be broadcast in charge-free within the predetermined time period is now complete.

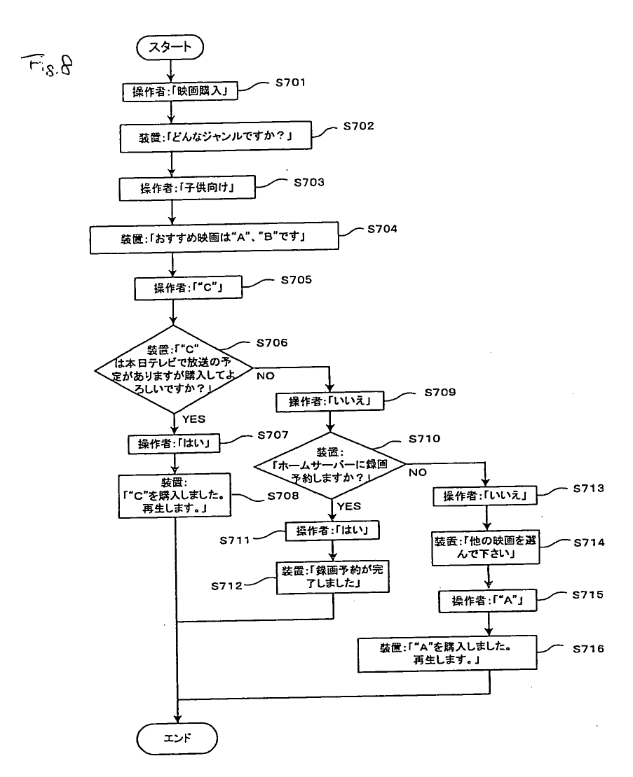

Next, the content purchase processing will be discussed in detail. FIG. 7 is a flowchart to show a procedure of the content purchase processing. First, the content purchase processing section 14 performs identity authentication processing with the pay content server (not shown) (step S601). If the authentication results in success, the content purchase processing section 14 performs charging processing (step S602) and then starts to download the content (step S603). Known techniques may be used for the authentication processing, the charging processing, and the download procedure.

The content playback processing is processing of playing back the downloaded content according to a known technique and will not be discussed here.

Next, a specific processing flow of the content purchase support apparatus for performing the described operation will be discussed.

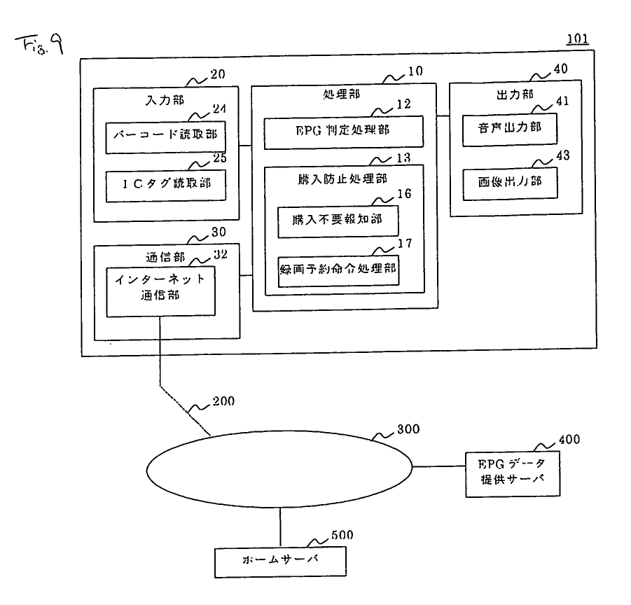

FIG. 8 is a flowchart to show a processing procedure example for the user (operator) to purchase pay content with the content purchase support apparatus installed in a vehicle-installed AV machine. In the figure, voice produced by the user (operator) is enclosed in “ . . . ” of USER (OPERATOR): “ . . . ” and voice produced by the content purchase support apparatus is enclosed in “ . . . ” of APPARATUS: “ . . . ”

To begin with, when the user (operator) specifies “movie purchase” by voice (step S701), the content search processing section 11 understands the entry by voice recognition and outputs an inquiry “which genre?” by voice through the voice synthesis processing section 42 and the voice output section 41 (step S702). If the user (operator) specifies “child-oriented” by voice (step S703) several candidates are output by voice out of a list of child-oriented movies acquired according to the search procedure described above (step S704).

If the user (operator) specifies any desired content (step S705), the EPG determination processing section 12 checks to see if the same content as the specified content will be broadcast in charge-free within the preset time period. Here, a processing procedure example when the content will be broadcast in charge-free is shown. If it is checked that the content will be broadcast in charge-free, the purchase nonnecessity notification section 16 notifies the user (operator) that the content will be broadcast in charge-free and inquires whether or not the content is to be purchased by voice (step S706) If the user (operator) specifies purchase of the content by voice (step S707), the above-described content purchase processing is performed and the user (operator) is notified that the content has been purchased and then playing back the content is started (step S708).

On the other hand, if the user (operator) specifies no purchase of the content by voice (step S709), the purchase prevention processing section 13 inquires of the user (operator) by voice whether or not a record pre-selection instruction is to be transmitted to the home server 500 (step S710).

If the user (operator) specifies a record pre-selection instruction by voice (step S711) , the record pre-selection instruction processing section 17 sends a record pre-selection instruction and notifies the user (operator) by voice that the record pre-selection is complete (step S712) . If the user (operator) specifies no record pre-selection instruction by voice (step S713) , the content search processing section 11 prompts the user (operator) to again specify content by voice (step S714).

Here, a processing procedure example when the user (operator) specifies content which will not be broadcast in charge-free is shown. When the user (operator) specifies any desired content by voice (step S715), the above-described content purchase processing is performed for the content which will not be broadcast in charge-free, and the user (operator) is notified that the content has been purchased and then playing back the content is started (step S716).

As described above, in the content purchase support apparatus installed in a vehicle-installed AV machine in the first embodiment, various inputs/outputs are performed by voice, so that the user (operator) need not perform key operation or visually check the display.

In the first embodiment, the content purchase support apparatus installed in a vehicle-installed AV machine is taken as an example and therefore voice input/output is performed. However, the content purchase support apparatus installed in an AV machine of a stay-at-home model, etc., would be able to realize the spirit of the invention without using any functions of voice synthesis or voice recognition in such a manner that the content search result is displayed on a screen or that the user (operator) specifies content by key input, needless to say.

In the embodiment described above, broadcast in charge-free content (namely, TV program) is recorded in the home server on the Internet, but broadcast content received at the TV reception section 31 may be recorded in the content purchase support apparatus 100.

However, with the content purchase support apparatus installed in a vehicle-installed AV machine, the reception state of a TV broadcast wave may become worse depending on the vehicle running state and therefore preferably content is recorded in a remote recording apparatus.

Second Embodiment

A content purchase support apparatus of a second embodiment of the invention will be discussed.

The embodiment is an example of a content purchase support apparatus that can be installed in a portable terminal such as a mobile telephone.

FIG. 9 is a block diagram to show the internal configuration of the content purchase support apparatus in the second embodiment of the invention. Content purchase support apparatus 101 differs from the content purchase support apparatus 100 of the first embodiment in that it includes a bar code read section 24 and an IC tag read section 25 in place of the voice input section 21 and the key input section 23 and does not include the voice recognition processing section 22, the content search processing section 11, the content purchase processing section 14, the content playback processing section 15, the TV reception section 31, the voice synthesis processing section 42, or The record section 50.

The content purchase support apparatus 101 reads title information from the bar code or the IC tag put on the package of a sold or rented DVD, etc., and checks and determines whether or not the same content as the content recorded on the DVD, etc., will be broadcast in charge-free within a predetermined time period, whereby the user can be prevented from purchasing or renting an unnecessary DVD, etc.

A specific processing flow of the content purchase support apparatus 101 will be discussed.

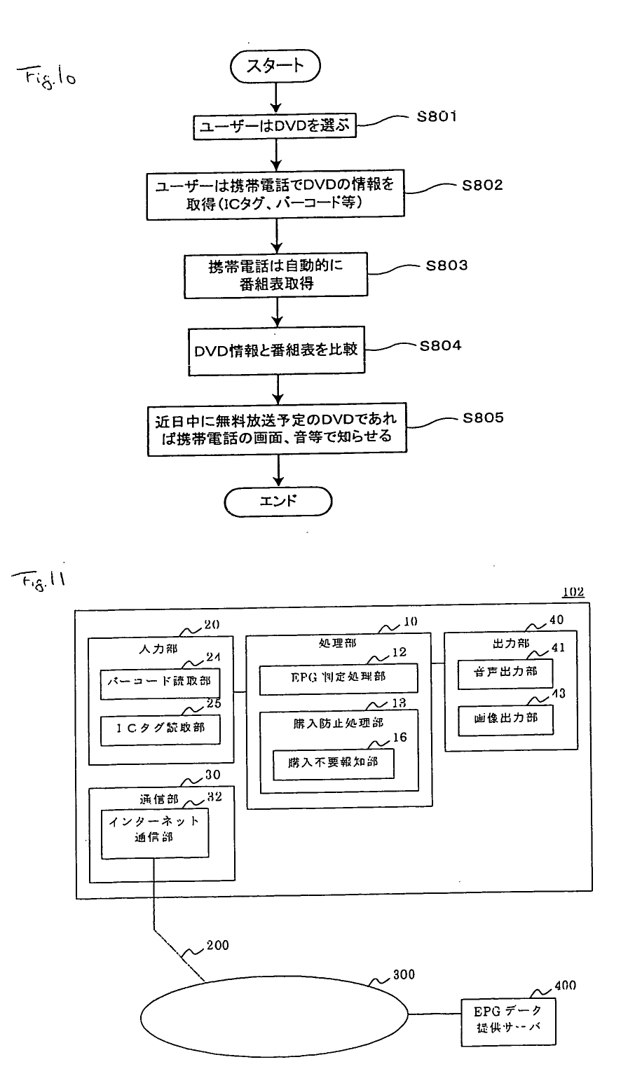

FIG. 10 is a flowchart to show a processing procedure example for the content purchase support apparatus installed in a mobile telephone terminal to determine whether or not the content recorded on a DVD, etc., will be broadcast in charge-free. To begin with, when the user (operator) of the content purchase support apparatus 101 selects a DVD, etc., (step S801) and read operation is performed, an input section 20 reads the title information of the DVD, etc., (step S802) and an EPG determination processing section 12 acquires EPG data from an EPG data providing server 400 via an Internet communication section 32, a radio telephone network 200, and an Internet network 300 (step S803).

The EPG determination processing section 12 makes a comparison between the read title information and the titles contained in the EPG data (step S804) . If the content will be broadcast in charge-free within the previously specified time period, a purchase nonnecessity notification section 16 notifies the user (operator) that the content will be broadcast in charge-free (step S805).

This notification is made by voice or by displaying an image. According to the described procedure, the user (operator) can keep track of whether or not the content of the DVD, etc., to be purchased or rented will be broadcast in charge-free, so that the user can be prevented from purchasing or renting an unnecessary DVD, etc.

A record pre-selection instruction processing section 17 can access a home server 500 via the Internet communication section 32, the radio telephone network 200, and the Internet network 300 and can give the home server 500 a record pre-selection instruction of the same program which will be broadcast in charge-free as the title of the DVD, etc., whose title information is read.

Third Embodiment

A content purchase support apparatus of a third embodiment of the invention will be discussed.

The embodiment is an example of a content purchase support apparatus that can be installed in a register terminal or a cashier terminal in a store.

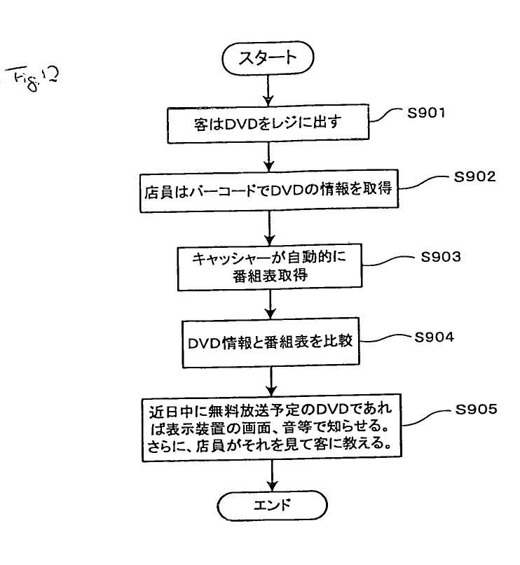

FIG. 11 is a block diagram to show the internal configuration of the content purchase support apparatus in the third embodiment of the invention. Content purchase support apparatus 102 differs from the content purchase support apparatus 101 of the second embodiment in that it does not include the record pre-selection instruction processing section 17.

The content purchase support apparatus 102 reads title information from the bar code or the IC tag put on the package of a DVD, etc., that the customer attempts to purchase or rent, and checks and determines whether or not the content recorded on the DVD, etc., will be broadcast in charge-free within a predetermined time period, whereby service for preventing the user from purchasing or renting an unnecessary DVD, etc., can be provided.

A specific processing flow of the content purchase support apparatus 102 will be discussed.

FIG. 12 is a flowchart to show a processing procedure example for the content purchase support apparatus installed in a cashier terminal to determine whether or not the content recorded on a DVD, etc., will be broadcast in charge-free. To begin with, when a customer carries a DVD, etc., to a cashier (step S901) and the user of the content purchase support apparatus 102 (in this case, salesclerk) performs read operation, an input section 20. reads the title information of the DVD, etc., (step S902) and an EPG determination processing section 12 acquires EPG data from an EPG data providing server 400 via an Internet communication section 32, a radio telephone network 200, and an Internet network 300 (step 903).

The EPG determination processing section 12 makes a comparison between the read title information and the titles contained in the EPG data (step S904). If the content will be broadcast in charge-free within the previously specified time period, a purchase nonnecessity notification section 16 notifies the user (salesclerk) that the content will be broadcast in charge-free (step S905).

This notification is made by voice or by displaying an image. According to the described procedure, the salesclerk can keep track of whether or not the content of the DVD, etc., that the customer attempts to purchase or rent will be broadcast in charge-free, and can provide the customer with information as to whether or not the content of the DVD, etc., will be broadcast in charge-free, so that service for preventing the user from purchasing or renting an unnecessary DVD, etc., can be provided.

The DVD, etc., mentioned in the second and third embodiments refers to the whole record media recording content and may be other types of record media. For example, if electronic program data of FM broadcasts, etc., is available and contains a title list of broadcast musical pieces, the invention can be applied not only a DVD, but also to a music CD so as to prevent the user (operator) from purchasing or renting an unnecessary CD.

In each of the embodiments, the configuration for purchasing pay content through the Internet has been described, but the invention can also be easily applied to the case where the user (operator) purchases a PPV (pay per view) program, etc., provided by a cable TV or a satellite broadcast, needless to say. At the time, the communication section 30 is provided with a cable TV communication section or a satellite broadcast communication section.

As described above, the content purchase support apparatus in each of the embodiments includes the content specification unit (11, 21, and 22) for the user to specify pay content to be purchased according to user's entry; the content determination unit (EPG determination processing section 12) for determining based on program information whether or not the same content as the pay content specified by the user through the content specification unit (11, 21, and 22) will be broadcast in charge-free within a predetermined time period; and the purchase prevention processing unit (purchase prevention processing section 13) for performing purchase prevention processing of the specified pay content if the content determination unit (EPG determination processing section 12) determines that the same content as the specified pay content will be broadcast in charge-free within the predetermined time period.

Accordingly, the user can be prevented from purchasing the same content on a chargeable basis without knowing the fact that the content will be broadcast in charge-free.

Although the present invention has been shown and described with reference to the preferred embodiments, various changes and modifications will be apparent to those skilled in the art from the teachings herein. Such changes and modifications as are obvious are deemed to come within the spirit, scope and contemplation of the invention as defined in the appended claims.

1. A content purchase support apparatus comprising:
a content specification unit that allows a user to input an entry for specifying pay content to be purchased;
a content determination unit that determines based on program information whether or not content same as the pay content specified by the user through the content specification unit is broadcast in charge-free within a predetermined time period; and
a purchase prevention processing unit that performs purchase prevention processing of the specified pay content when the content determination unit determines that the content same as the specified pay content will be broadcast in charge-free within the predetermined time period.

2. The content purchase support apparatus as claimed in claim 1, further comprising an assistance information providing unit that provides assistance information to assist the user in inputting the entry before the user specifies the pay content to be purchased through the content specification unit.

3. The content purchase support apparatus as claimed in claim 2, further comprising:
a storage unit that stores information concerning a plurality of pieces of content;
a search condition setting unit that allows the user to set a search condition before the user specifies the pay content to be purchased through the content specification unit; and
a search unit that searches for the information concerning a plurality of pieces of content stored in the storage unit based on the search condition,
wherein the assistance information providing unit provides the assistance information based on the information concerning the content found by the search unit.

4. The content purchase support apparatus as claimed in claim 3, further comprising a search information determination unit that determines based on the program information whether or not the information concerning the content found by the search unit includes information concerning the content which will be broadcast in charge free within the predetermined time period,
wherein the assistance information providing unit provides no assistance information when the search information determination unit determines that the found information concerning the content includes information concerning the content which is broadcast in charge-free within the predetermined time period.

5. The content purchase support apparatus as claimed in claim 1, further comprising:
a confirmation information providing unit that provides confirmation information as to whether or not the user is to purchase the specified pay content to the user when the purchase prevention processing unit performs the purchase prevention processing of the specified pay content; and
a purchase determination unit that determines whether or not the specified pay content is purchased according to an entry input by the user after the confirmation information providing unit provides the confirmation information,
wherein the purchase prevention processing unit performs the purchase prevention processing of the specified pay content based on the determination result of the purchase determination unit.

6. The content purchase support apparatus as claimed in claim 5, wherein when the purchase determination unit determines that the specified pay content is purchased, the purchase prevention processing unit performs no processing.

7. The content purchase support apparatus as claimed in claim 5, further comprising a record command unit that issuing a record command to a recording apparatus capable of receiving and recording content that is broadcast in charge-free within the predetermined time period for causing the recording apparatus to record the content that is broadcast in charge-free when the purchase determination unit determines that the specified pay content is not purchased.

8. A content purchase support method comprising:
a content specification step for allowing a user to input an entry for specifying pay content to be purchased;
a content determination step for determining based on program information whether or not content same as the pay content specified by the user will be broadcast in charge-free within a predetermined time period; and
a purchase prevention processing step for performing purchase prevention processing of the specified pay content when determined in the content determination step that the content same as the specified pay content is broadcast in charge-free within the predetermined time period.

9. A content purchase support program product for causing a computer to execute:
a content specification step for allowing a user to input an entry for specifying pay content to be purchased;
a content determination step for determining based on program information whether or not content same as the pay content specified by the user will be broadcast in charge-free within a predetermined time period; and
a purchase prevention processing step for performing purchase prevention processing of the specified pay content when determined in the content determination step that the content same as the specified pay content is broadcast in charge-free within the predetermined time period.
